(19) United States
(12) Patent Application Publication
(10) Pub. No.: US 2015/0172694 A1
(43) Pub. Date: Jun. 18, 2015

(54) MOVING PICTURE ENCODING METHOD, MOVING PICTURE DECODING METHOD, MOVING PICTURE ENCODING APPARATUS, MOVING PICTURE DECODING APPARATUS, MOVING PICTURE ENCODING PROGRAM, MOVING PICTURE DECODING PROGRAM, AND RECORDING MEDIA

(71) Applicant: NIPPON TELEGRAPH AND TELEPHONE CORPORATION, Tokyo (JP)

(72) Inventors: Shinya Shimizu, Yokosuka-shi (JP); Shiori Sugimoto, Yokosuka-shi (JP); Hideaki Kimata, Yokosuka-shi (JP); Akira Kojima, Yokosuka-shi (JP)

(73) Assignee: NIPPON TELEGRAPH AND TELEPHONE CORPORATION, Tokyo (JP)

(21) Appl. No.: 14/413,349

(22) PCT Filed: Jul. 9, 2013
(86) PCT No.: PCT/JP2013/068698

§ 371 Date: Jan. 7, 2015

(30) Foreign Application Priority Data
Jul. 9, 2012 (JP) 2012-154066

(51) Int. Cl. H04N 19/513; H04N 19/172

(52) U.S. Cl. CPC H04N 19/513; H04N 19/172

(57) ABSTRACT

A bit amount necessary to code information for generating a predicted picture when predictive encoding is performed on a moving picture is reduced. A reference frame list, which is a list of reference frames to be referred to when a predicted picture is generated, is generated. Motion information used when a texture moving picture corresponding to a processing region is encoded is set as texture motion information. Depth map motion information representing a region on a reference frame corresponding to the processing region is set. At this time, the texture motion information is set as the depth map motion information if an index value designating a reference frame included in the texture motion information is less than the size of the reference frame list. The predicted picture for the processing region is generated in accordance with the set depth map motion information.

### TECHNICAL FIELD

The present invention relates to a moving picture encoding method, a moving picture decoding method, a moving picture encoding apparatus, a moving picture decoding apparatus, a moving picture encoding program, a moving picture decoding program, and recording media.

Priority is claimed on Japanese Patent Application No. 2012-154066, filed Jul. 9, 2012, the content of which is incorporated herein by reference.

### BACKGROUND ART

A free viewpoint picture in which a user can freely designate a position and direction (hereinafter referred to as a view) of a camera within a photographing space is conventionally known. Because the user can designate any view in the free viewpoint picture, it is impossible to hold all possible pictures. Therefore, the free viewpoint picture is configured by an information group necessary for generating a picture of the designated view. Although the free viewpoint picture is represented using various data formats, the most common format is a scheme using a picture and a depth map (distance picture) for the picture (e.g., see Non-Patent Document 1).

Here, the depth map represents depth (the distance) from a camera to an object for each pixel and it represents a three-dimensional position of the object. Because the depth is proportional to the reciprocal of a disparity between two cameras, the depth map is also referred to as a disparity map (disparity picture). In the field of computer graphics, the depth is information stored in a Z-buffer, and thus the depth map may also be referred to as a Z-picture or a Z-map. It is to be noted that instead of the distance from the camera to the object, coordinate values for a Z-axis of a three-dimensional coordinate system extended on a space to be represented may also be used as the depth. In general, a Z-axis agrees with the direction of a camera because the horizontal direction for a captured picture is set as an X-axis and the vertical direction therefor is set as a Y-axis, but the Z-axis may not agree with the direction of the camera such as when a coordinate system common to a plurality of cameras is used. Hereinafter, a distance and a Z-value are both referred to as depth without being distinguished and a picture in which the depth is represented as a pixel value is referred to as a depth map. However, strictly speaking, with respect to the disparity map, it is necessary to set a pair of reference cameras.

When the depth is represented as a pixel value, there is a method for setting a value itself corresponding to a physical quantity as the pixel value, a method using a value obtained by performing quantization so that a certain number of values are present between a minimum value and a maximum value, and a method using a value obtained by quantizing the difference between the depth and the minimum value with a certain step size. When a range to be represented is limited, it is possible to represent the depth with high accuracy by using additional information such as a minimum value. In addition, when equally-spaced quantization is performed, there is a method for quantizing a physical quantity itself and a method for quantizing the reciprocal of the physical quantity. Because the reciprocal of a distance becomes a value proportional to a disparity, the former method is normally used if it is necessary to represent the distance with high accuracy and the latter method is normally used if it is necessary to represent the disparity with high accuracy. Hereinafter, any picture representing the depth is referred to as a depth map regardless of a method for representing the depth as a pixel value and a method for quantizing the depth.

Because the depth map is represented as a picture in which each pixel has one value, the depth map can be regarded as a grayscale picture. In addition, because an object is continuously present on a real space and it is impossible to instantaneously move the object to a distant position, the depth map is said to have a spatial correlation and a temporal correlation as in a picture signal. Therefore, it is possible to efficiently code the depth map and its moving picture (a depth map moving picture or a depth video) while removing spatial and temporal redundancy using a normal picture coding scheme or a normal moving picture coding scheme to be used to code a picture signal or a video signal.

Here, general moving picture coding will be described. In order to realize efficient coding using a feature that an object is spatially continuous, in the moving picture coding, each picture (frame) constituting a moving picture is divided into processing unit blocks each having a predetermined number of pixels, a picture signal is spatially or temporally predicted for each block, and prediction information representing a prediction method thereof and a prediction residual are encoded. If the picture signal is spatially predicted, the prediction information is, for example, information representing a direction of spatial prediction. If the picture signal is temporary predicted, the prediction information is, for example, information representing a picture to be referred to and information representing a position in the picture to be referred to.

Because the spatial or temporal correlation of picture signals depends upon an object and texture, recent moving picture coding represented by H.264/AVC makes it possible to perform division into finer blocks in accordance with a picture signal for each processing unit block and predict a picture signal while referring to a different picture or region for a different block. In particular, H.264/AVC makes it possible to select one or two pictures from a plurality of pictures of different times for each block and refer to the pictures for each block, thereby realizing high coding efficiency for moving picture coding in which pictures to be referred to are fixed as in MPEG-2 and MPEG-4 (see, for example, Non-Patent Document 2 for details of H.264/AVC). This is because it is possible to refer to a picture having a higher temporal correlation when there is occlusion or periodic motion of the object.

Each of a plurality of pictures capable of being referred to is set as an entry of a list called a reference picture list, and an index value thereof is encoded to represent a picture that is referred to. In coding of the index value of the reference picture, a larger bit amount is necessary when the number of entries of reference pictures is larger and when its index value is larger. Thus, higher coding efficiency can be achieved by excluding a picture having a low temporal correlation from the list and allocating an index value having a larger value to a picture having a low temporal correlation. Because the temporal correlation of each picture depends upon a sequence and the processing target picture, H.264/AVC makes it possible to construct a different reference picture list for a different picture.

In coding of a free viewpoint moving picture configured by a moving picture and a depth map moving picture, both pictures have the spatial correlation and the temporal correlation, and thus it is possible to reduce a data amount by coding the pictures using a normal moving picture coding scheme. For example, when the moving picture and the depth map moving picture therefor are represented using MPEG-C Part. 3, the pictures are coded using an existing moving picture coding scheme.

In addition, because a moving picture and a depth map moving picture are information for the same object and space, there is a method for realizing efficient coding using a correlation present therebetween when the moving picture and the depth map moving picture are coded together. Non-Patent Document 3 realizes efficient coding by employing common motion information (a reference picture index and a motion vector) to be used when the moving picture and the depth map moving picture are coded to avoid duplicate coding. Specifically, one piece of motion information is generated in view of both the moving picture and the depth map moving picture and is commonly used.

### PRIOR ART DOCUMENTS

### Non-Patent Documents

Non-Patent Document 1: Y. Mori, N. Fukushima, T. Fujii, and M. Tanimoto, “View Generation with 3D Warping Using Depth Information for FTV”, In Proceedings of 3DTV-CON2008, pp. 229 to 232, May 2008.
Non-Patent Document 2: Recommendation ITU-T H.264, “Advanced video coding for generic audiovisual services”, March 2009.
Non-Patent Document 3: I. Daribo, C. Tillier, and B. P. Popescu, “Motion Vector Sharing and Bitrate Allocation for 3D Video-Plus-Depth Coding”, EURASIP Journal on Advances in Signal Processing, vol. 2009, Article ID 258920, 13 pages, 2009.

### SUMMARY OF INVENTION

### Problems to be Solved by the Invention

As in the above-described Non-Patent Document 3, when the moving picture and the depth map moving picture have a common reference picture list structure and the moving picture and the depth map moving picture share motion information, it is possible to reduce an amount of motion information to be coded, and thus it is possible to realize highly efficient compression coding of a free viewpoint moving picture configured by a picture signal and depth.

However, because the moving picture and the depth map moving picture have different properties and a different frame has a different property in terms of the temporal correlation, there is a problem in that it is impossible to perform appropriate prediction and a prediction residual increases when the motion information is always shared. That is, even if the method of the above-described Non-Patent Document 3 can reduce an amount of motion information, the entire bit amount increases and it is impossible to realize efficient compression coding when the prediction residual significantly increases.

In addition, because a depth map is acquired by stereo matching from a multiview picture or by a sensor using infrared light or the like, which is different from that of general picture capturing, noise increases and the temporal correlation is much lower than that of a moving picture. Thus, in coding of a depth map, it is possible to efficiently code a reference picture index using a reference picture list having a small number of entries by not including a frame significantly separated from a processing target frame in time in the reference picture list. However, if a reference picture list of a moving picture and its structure are shared, the bit amount increases because it is necessary to code a reference picture index using the reference picture list having many entries.

As an easily conceivable method to address this problem, there is a method for coding a flag representing whether motion information can be shared for each separately defined region using different reference picture lists for the moving picture and the depth map moving picture so that data of the moving picture and depth map moving picture is efficiently coded. However, this method has a problem in that it is necessary to code a flag for each region and thus the bit amount increases accordingly. In addition, because it is necessary for corresponding entries of the reference picture lists to include reference frames of the same time and the same type in order to share motion information, there is also a problem in that the number of regions in which motion information can be shared is reduced and the bit amount necessary for coding the motion information increases.

The present invention has been made in view of such circumstances, and an object thereof is to provide a moving picture encoding method, a moving picture decoding method, a moving picture encoding apparatus, a moving picture decoding apparatus, a moving picture encoding program, a moving picture decoding program, and recording media which realize efficient moving picture coding in coding of a free viewpoint moving picture having a moving picture and a depth map moving picture as constituent elements.

### Means for Solving the Problems

The present invention is a moving picture encoding method for dividing each frame constituting a depth map moving picture into processing regions each having a predetermined size and performing predictive encoding for each of the processing regions while using motion information when a texture moving picture corresponding to the depth map moving picture is encoded, and the method includes: a depth map reference frame list generating step of generating a reference frame list which is a list of reference frames to be referred to when a predicted picture is generated; a texture motion information setting step of setting motion information used when the texture moving picture corresponding to a processing region is encoded as texture motion information; a depth map motion information setting step of setting depth map motion information representing a region on a reference frame corresponding to the processing region, the depth map motion information setting step setting the texture motion information as the depth map motion information if an index value designating a reference frame included in the texture motion information is less than the size of the reference frame list; and a predicted picture generating step of generating the predicted picture for the processing region in accordance with the set depth map motion information.

Preferably, in the present invention, the depth map motion information setting step sets, if a frame having the same property as a frame represented by the texture motion information is included in the reference frame list, motion information in which a reference frame index of the texture motion information is changed to an index representing the frame having the same property, as the depth map motion information.

Preferably, the present invention further includes: a texture reference frame list setting step of setting a reference frame list used when the texture moving picture is encoded as a texture reference frame list; a conversion table generating step of generating a conversion table which converts a reference frame index for the texture reference frame list into a reference frame index for the reference frame list, the conversion table generating step setting the conversion table so that a property of a frame within the texture reference frame list represented by the reference frame index before conversion is equal to a property of a frame within the reference frame list represented by the reference frame index after the conversion; and a motion information converting step of generating converted motion information by performing conversion on an index value designating a reference frame included in the texture motion information in accordance with the conversion table, and the depth map motion information setting step sets the converted motion information as the depth map motion information if the frame having the same property as the frame represented by the texture motion information is included in the reference frame list.

The present invention is a moving picture encoding method for dividing each frame constituting a depth map moving picture into processing regions each having a predetermined size and performing predictive encoding for each of the processing regions while using motion information when a texture moving picture corresponding to the depth map moving picture is encoded, and the method includes: a depth map reference frame list generating step of generating a reference frame list which is a list of reference frames to be referred to when a predicted picture is generated; a texture motion information setting step of setting motion information used when the texture moving picture corresponding to a processing region is encoded as texture motion information; a shared motion information list generating step of generating a shared motion information list generated by listing motion information used when a region temporally or spatially adjacent to the processing region is encoded, the shared motion information list generating step generating the shared motion information list including the texture motion information if an index value designating a reference frame included in the texture motion information is less than the size of the reference frame list; a depth map motion information setting step of selecting one piece of motion information from the motion information included in the shared motion information list and setting the selected motion information as motion information for the processing region; and a predicted picture generating step of generating the predicted picture for the processing region in accordance with the set depth map motion information.

Preferably, in the present invention, the shared motion information list generating step generates, if a frame having the same property as a frame represented by the texture motion information is included in the reference frame list, the shared motion information list including motion information in which a reference frame index of the texture motion information is changed to an index representing the frame having the same property.

Preferably, the present invention further includes: a texture reference frame list setting step of setting a reference frame list used when the texture moving picture is encoded as a texture reference frame list; a conversion table generating step of generating a conversion table which converts a reference frame index for the texture reference frame list into a reference frame index for the reference frame list, the conversion table generating step setting the conversion table so that a property of a frame within the texture reference frame list represented by the reference frame index before conversion is equal to a property of a frame within the reference frame list represented by the reference frame index after the conversion; and a motion information converting step of generating converted motion information by performing conversion on an index value designating a reference frame included in the texture motion information in accordance with the conversion table, and the shared motion information list generating step generates the shared motion information list including the converted motion information if the frame having the same property as the frame represented by the texture motion information is included in the reference frame list.

The present invention is a moving picture decoding method for, when decoding is performed on encoded data of a depth map moving picture, dividing each frame constituting the depth map moving picture into processing regions each having a predetermined size and performing decoding while predicting a depth map for each of the processing regions using motion information used when a texture moving picture corresponding to the depth map moving picture is decoded, and the method includes: a depth map reference frame list setting step of setting a reference frame list which is a list of reference frames to be referred to when a predicted picture is generated; a texture motion information setting step of setting motion information used when the texture moving picture corresponding to a processing region is decoded as texture motion information; a depth map motion information setting step of setting depth map motion information representing a region on a reference frame corresponding to the processing region, the depth map motion information setting step setting the texture motion information as the depth map motion information if an index value designating a reference frame included in the texture motion information is less than the size of the reference frame list; and a predicted picture generating step of generating the predicted picture for the processing region in accordance with the set depth map motion information.

Preferably, in the present invention, the depth map motion information setting step sets, if a frame having the same property as a frame represented by the texture motion information is included in the reference frame list, motion information in which a reference frame index of the texture motion information is changed to an index representing the frame having the same property, as the depth map motion information.

Preferably, the present invention further includes: a texture reference frame list setting step of setting a reference frame list used when the texture moving picture is decoded as a texture reference frame list; a conversion table generating step of generating a conversion table which converts a reference frame index for the texture reference frame list into a reference frame index for the reference frame list, the conversion table generating step setting the conversion table so that a property of a frame within the texture reference frame list represented by the reference frame index before conversion is equal to a property of a frame within the reference frame list represented by the reference frame index after the conversion; and a motion information converting step of generating converted motion information by performing conversion on an index value designating a reference frame included in the texture motion information in accordance with the conversion table, and the depth map motion information setting step sets the converted motion information as the depth map motion information if the frame having the same property as the frame represented by the texture motion information is included in the reference frame list.

The present invention is a moving picture decoding method for, when decoding is performed on encoded data of a depth map moving picture, dividing each frame constituting the depth map moving picture into processing regions each having a predetermined size and performing decoding while predicting a signal of a depth map for each of the processing regions using motion information used when a texture moving picture corresponding to the depth map moving picture is decoded, and the method includes: a depth map reference frame list setting step of setting a reference frame list which is a list of reference frames to be referred to when a predicted picture is generated; a texture motion information setting step of setting motion information used when the texture moving picture corresponding to a processing region is decoded as texture motion information; a shared motion information list generating step of generating a shared motion information list generated by listing motion information used when a region temporally or spatially adjacent to the processing region is decoded, the shared motion information list generating step generating the shared motion information list including the texture motion information if an index value designating a reference frame included in the texture motion information is less than the size of the reference frame list; a depth map motion information setting step of selecting one piece of motion information from the motion information included in the shared motion information list and setting the selected motion information as motion information for the processing region; and a predicted picture generating step of generating the predicted picture for the processing region in accordance with the set depth map motion information.

Preferably, in the present invention, the shared motion information list generating step generates, if a frame having the same property as a frame represented by the texture motion information is included in the reference frame list, the shared motion information list including motion information in which a reference frame index of the texture motion information is changed to an index representing the frame having the same property.

Preferably, the present invention further includes: a texture reference frame list setting step of setting a reference frame list used when the texture moving picture is decoded as a texture reference frame list; a conversion table generating step of generating a conversion table which converts a reference frame index for the texture reference frame list into a reference frame index for the reference frame list, the conversion table generating step setting the conversion table so that a property of a frame within the texture reference frame list represented by the reference frame index before conversion is equal to a property of a frame within the reference frame list represented by the reference frame index after the conversion; and a motion information converting step of generating converted motion information by performing conversion on an index value designating a reference frame included in the texture motion information in accordance with the conversion table, and the shared motion information list generating step generates the shared motion information list including the converted motion information if the frame having the same property as the frame represented by the texture motion information is included in the reference frame list.

The present invention is a moving picture encoding apparatus for dividing each frame constituting a depth map moving picture into processing regions each having a predetermined size and performing predictive encoding for each of the processing regions while using motion information when a texture moving picture corresponding to the depth map moving picture is encoded, and the apparatus includes: a depth map reference frame list generating unit which generates a reference frame list which is a list of reference frames to be referred to when a predicted picture is generated; a texture motion information setting unit which sets motion information used when the texture moving picture corresponding to a processing region is encoded as texture motion information; a depth map motion information setting unit which sets depth map motion information representing a region on a reference frame corresponding to the processing region, the depth map motion information setting unit setting the texture motion information as the depth map motion information if an index value designating a reference frame included in the texture motion information is less than the size of the reference frame list; and a predicted picture generating unit which generates the predicted picture for the processing region in accordance with the set depth map motion information.

The present invention is a moving picture encoding apparatus for dividing each frame constituting a depth map moving picture into processing regions each having a predetermined size and performing predictive encoding for each of the processing regions while using motion information when a texture moving picture corresponding to the depth map moving picture is encoded, and the apparatus includes: a depth map reference frame list generating unit which generates a reference frame list which is a list of reference frames to be referred to when a predicted picture is generated; a texture motion information setting unit which sets motion information used when the texture moving picture corresponding to a processing region is encoded as texture motion information; a shared motion information list generating unit which generates a shared motion information list generated by listing motion information used when a region temporally or spatially adjacent to the processing region is encoded, the shared motion information list generating unit generating the shared motion information list including the texture motion information if an index value designating a reference frame included in the texture motion information is less than the size of the reference frame list; a depth map motion information setting unit which selects one piece of motion information from the motion information included in the shared motion information list and sets the selected motion information as motion information for the processing region; and a predicted picture generating unit which generates the predicted picture for the processing region in accordance with the set depth map motion information.

The present invention is a moving picture decoding apparatus for, when decoding is performed on encoded data of a depth map moving picture, dividing each frame constituting the depth map moving picture into processing regions each having a predetermined size and performing decoding while predicting a depth map for each of the processing regions using motion information used when a texture moving picture corresponding to the depth map moving picture is decoded, and the apparatus includes: a depth map reference frame list setting unit which sets a reference frame list which is a list of reference frames to be referred to when a predicted picture is generated; a texture motion information setting unit which sets motion information used when the texture moving picture corresponding to a processing region is decoded as texture motion information; a depth map motion information setting unit which sets depth map motion information representing a region on a reference frame corresponding to the processing region, the depth map motion information setting unit setting the texture motion information as the depth map motion information if an index value designating a reference frame included in the texture motion information is less than the size of the reference frame list; and a predicted picture generating unit which generates the predicted picture for the processing region in accordance with the set depth map motion information.

The present invention is a moving picture decoding apparatus for, when decoding is performed on encoded data of a depth map moving picture, dividing each frame constituting the depth map moving picture into processing regions each having a predetermined size and performing decoding while predicting a signal of a depth map for each of the processing regions using motion information used when a texture moving picture corresponding to the depth map moving picture is decoded, and the apparatus includes: a depth map reference frame list setting unit which sets a reference frame list which is a list of reference frames to be referred to when a predicted picture is generated; a texture motion information setting unit which sets motion information used when the texture moving picture corresponding to a processing region is decoded as texture motion information; a shared motion information list generating unit which generates a shared motion information list generated by listing motion information used when a region temporally or spatially adjacent to the processing region is decoded, the shared motion information list generating unit generating the shared motion information list including the texture motion information if an index value designating a reference frame included in the texture motion information is less than the size of the reference frame list; a depth map motion information setting unit which selects one piece of motion information from the motion information included in the shared motion information list and sets the selected motion information as motion information for the processing region; and a predicted picture generating unit which generates the predicted picture for the processing region in accordance with the set depth map motion information.

The present invention is a moving picture encoding program for causing a computer to execute the moving picture encoding method.

The present invention is a moving picture decoding program for causing a computer to execute the moving picture decoding method.

The present invention is a computer-readable recording medium recording the moving picture encoding program.

The present invention is a computer-readable recording medium recording the moving picture decoding program.

### Advantageous Effects of the Invention

When data representing different pieces of information on the same object such as a moving picture signal and another depth map moving picture for the moving picture are encoded together, the present invention generates a conversion table representing a correspondence relationship between entries of reference picture lists to be managed and performs conversion on information designating a reference picture in accordance with the correspondence relationship. Thus, it is possible to share motion information and reduce a bit amount thereof even when different reference picture lists are used. Furthermore, it is possible to reduce a bit amount necessary for coding information representing whether to share the motion information by determining motion information which is not shareable from the correspondence relationship. As a result, there is an advantageous effect in that it is possible to realize efficient moving picture coding.

### BRIEF DESCRIPTION OF DRAWINGS

FIG. 1 is a block diagram illustrating a configuration of a moving picture encoding apparatus in accordance with an embodiment of the present invention.

FIG. 2 is a flowchart illustrating an operation of the moving picture encoding apparatus 100 illustrated in FIG. 1.

FIG. 3 is a flowchart illustrating a processing operation when only part of shareable motion information is shared.

FIG. 4 is a block diagram illustrating a configuration of a moving picture decoding apparatus in accordance with an embodiment of the present invention.

FIG. 5 is a flowchart illustrating an operation of the moving picture decoding apparatus 200 illustrated in FIG. 4.

FIG. 6 is a flowchart illustrating a processing operation when only part of shareable motion information is shared.

FIG. 7 is a block diagram illustrating a hardware configuration when the moving picture encoding apparatus is configured by a computer and a software program.

FIG. 8 is a block diagram illustrating a hardware configuration when the moving picture decoding apparatus is configured by a computer and a software program.

### MODES FOR CARRYING OUT THE INVENTION

Hereinafter, an embodiment of the present invention will be described with reference to the drawings. It is to be noted that the present embodiment describes the case in which a depth map moving picture corresponding to a moving picture is encoded with referring to motion information of the moving picture, but it is obvious that the present invention is also applicable to the case in which a moving picture corresponding to a depth map moving picture is encoded with referring to motion information of the depth map. In addition, it is also obvious that the present invention is applicable not only to a moving picture and a depth map moving picture but also to a pair of any data capable of being represented as moving pictures in which the same object and space are photographed such as moving pictures of temperature information or moving pictures of different color components.

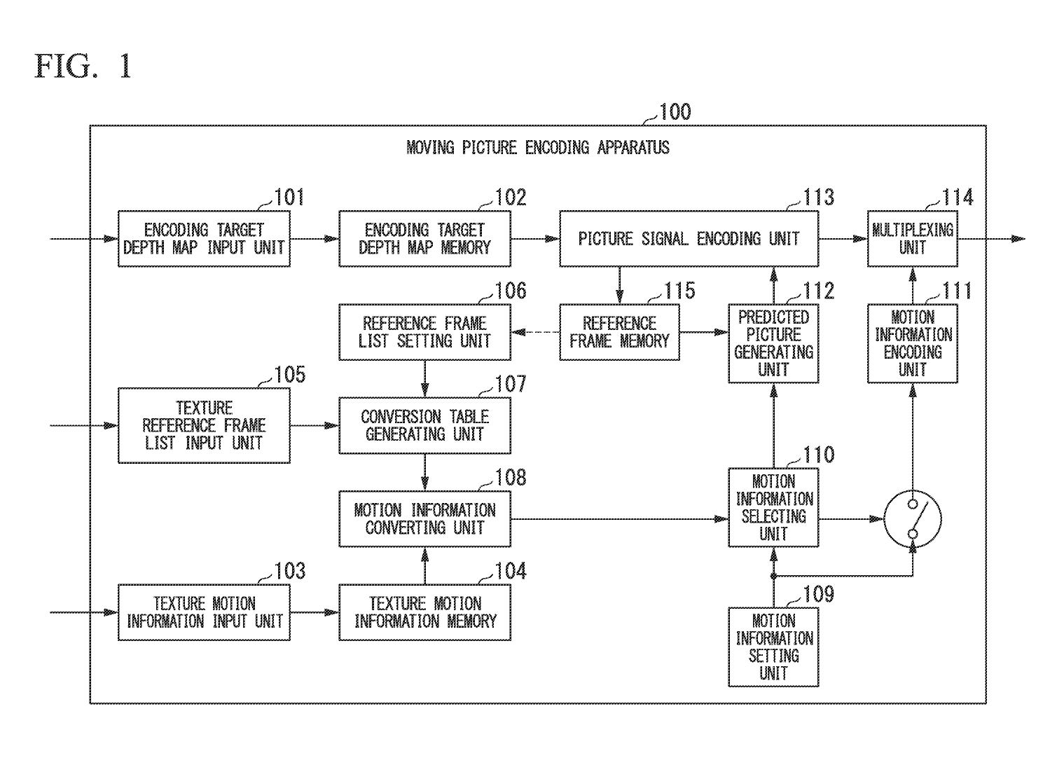

First, a moving picture encoding apparatus in the present embodiment will be described. FIG. 1 is a block diagram illustrating a configuration of the moving picture encoding apparatus in accordance with the embodiment of the present invention. As illustrated in FIG. 1, the moving picture encoding apparatus 100 includes an encoding target depth map input unit 101, an encoding target depth map memory 102, a texture motion information input unit 103, a texture motion information memory 104, a texture reference frame list input unit 105, a reference frame list setting unit 106, a conversion table generating unit 107, a motion information converting unit 108, a motion information setting unit 109, a motion information selecting unit 110, a motion information encoding unit 111, a predicted picture generating unit 112, a picture signal encoding unit 113, a multiplexing unit 114, and a reference frame memory 115.

The encoding target depth map input unit 101 inputs each frame of a depth map moving picture serving as an encoding target. In the following description, the depth map serving as the encoding target is referred to as an encoding target depth map moving picture. In particular, a frame to be processed is referred to as an encoding target depth map. The encoding target depth map memory 102 stores the input encoding target depth map. The texture motion information input unit 103 inputs motion information in a frame of a moving picture corresponding to the encoding target depth map. Here, the moving picture corresponding to the encoding target depth map moving picture is referred to as a texture moving picture, and one frame of the moving picture corresponding to the encoding target depth map is referred to as a texture frame. In addition, the motion information is information used when the texture moving picture is encoded and it is represented using a set of a reference frame index and a motion vector for each pixel or block. The texture motion information memory 104 stores the input texture motion information. The texture reference frame list input unit 105 inputs a reference frame list used when the texture frame is encoded.

The reference frame list setting unit 106 sets a reference frame list to be used in encoding the encoding target depth map. The conversion table generating unit 107 generates a lookup table which converts a reference frame index for the texture reference frame list into a reference frame index for the set reference frame list. The motion information converting unit 108 performs conversion on the reference frame index in the texture motion information in accordance with the generated lookup table.

The motion information setting unit 109 sets motion information for the encoding target depth map. The motion information selecting unit 110 selects either one of motion information obtained by performing conversion on the texture motion information and the motion information set by the motion information setting unit 109. The motion information encoding unit 111 encodes supplied motion information. The predicted picture generating unit 112 generates a predicted picture for the encoding target depth map in accordance with the selected motion information. The picture signal encoding unit 113 performs predictive encoding on the encoding target depth map using the generated predicted picture. The multiplexing unit 114 multiplexes a bitstream of the motion information and a bitstream of a picture signal and outputs a resultant bitstream. The reference frame memory 115 stores a decoded frame of an already encoded depth map to be used to generate the predicted picture.

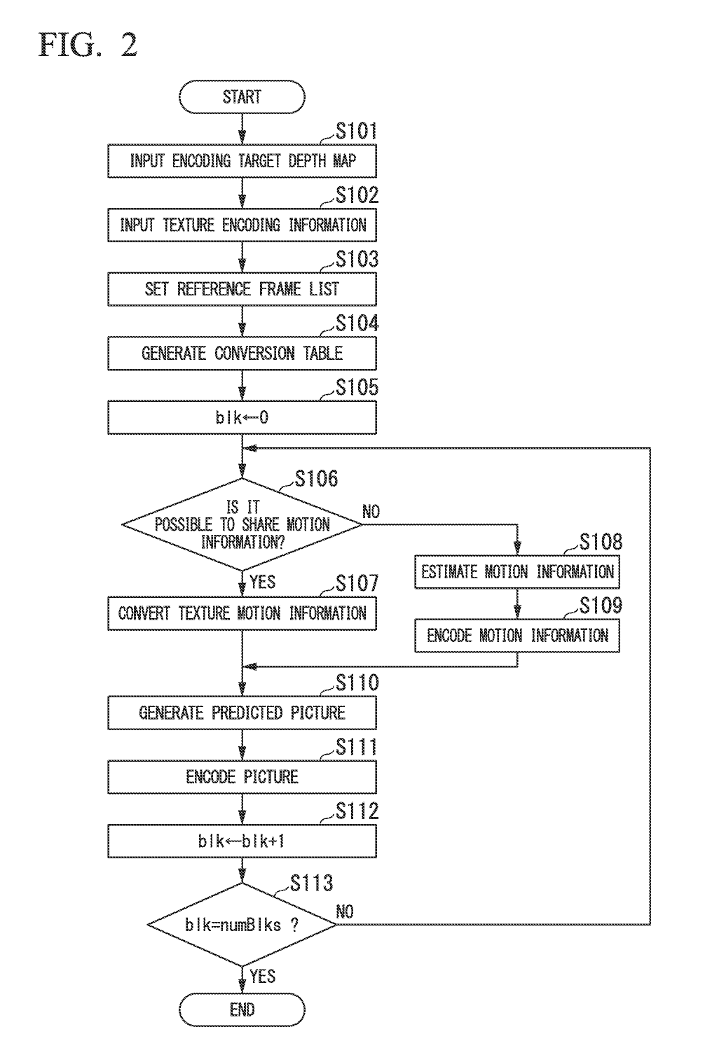

Next, an operation of the moving picture encoding apparatus 100 illustrated in FIG. 1 will be described with reference to FIG. 2. FIG. 2 is a flowchart illustrating an operation of the moving picture encoding apparatus 100 illustrated in FIG. 1. Here, a process of encoding a frame in an encoding target depth map moving picture will be described. It is possible to realize encoding of the encoding target depth map moving picture by iterating the described process for every frame.

First, the encoding target depth map input unit 101 inputs an encoding target depth map and stores it in the encoding target depth map memory 102 (step S101). In parallel therewith, the texture motion information input unit 103 inputs motion information used when a texture frame is encoded and stores it in the texture motion information memory 104. In addition, the texture reference frame list input unit 105 inputs a texture reference frame list which is a reference frame list used when the texture frame is encoded (step 102).

It is to be noted that it is assumed that some frames of the encoding target depth map moving picture are already encoded and their decoded frames are stored in the reference frame memory 115. Moreover, in addition to the frames obtained by decoding the already encoded frames, any frame may be included in the reference frame memory 115 as long as it is available in the decoding end. For example, when a multiview depth map moving picture is encoded together, an implementation in which a frame obtained by decoding a frame of a depth map moving picture for another view and/or a frame synthesized from the frame obtained by decoding the frame of the depth map moving picture for the other view are included in the reference frame memory 115 is preferable. Furthermore, when a corresponding multiview moving picture is encoded together, an implementation in which a depth map estimated by applying stereo matching to the multiview moving picture is included in the reference frame memory 115 is preferable.

In addition, although the present embodiment assumes that input encoding target depth maps are sequentially encoded, the input order is not necessarily identical to the encoding order. When the input order is different from the encoding order, an input frame, texture motion information, and texture reference frame list are stored in an appropriate memory until the next frame to be encoded is input. After a corresponding frame has been encoded by the encoding process to be described below, the stored information may be deleted from the memory.

Here, it is assumed that the encoding target depth map and the texture motion information are input on a frame-by-frame basis, but they may be input on a sequence-by-sequence. In this case, a texture reference frame list of each frame is input in step S102, and a memory for storing the input texture reference frame list is necessary. In addition, in contrast, the encoding target depth map and the texture motion information may be input for each encoding processing unit. In this case, because input encoding target depth maps and texture motion information are sequentially processed, the encoding target depth map memory 102 and the texture motion information memory 104 are unnecessary.

When the encoding target depth map and the texture motion information are stored and the input of the texture reference frame list is completed, the reference frame list setting unit 106 sets a reference frame list to be used when the encoding target depth map is encoded (step S103). Specifically, reference frame indices are allocated to frames stored in the reference frame memory 115 without overlap. It is to be noted that the reference frame indices do not necessarily have to be allocated to all decoded frames stored in the reference frame memory 115. In addition, when a plurality of reference frame lists are created, reference frame indices are allocated for each reference frame list without overlap.

Here, when the reference frame list is created, reference frame indices may be allocated using any method. As a simplest method, there is a method for sequentially allocating a smaller reference frame index to a reference frame closer to the encoding target depth map in terms of a photographed time. In addition, in order to realize efficient coding, an implementation in which a smaller reference frame index is allocated to a frame having a higher correlation with the encoding target depth map is preferable. Furthermore, rather than a correlation of the entire frame, a frame having a high correlation may be found for each block of the encoding target depth map and a smaller reference frame index may be allocated to a frame having a high correlation with a larger number of blocks. There is also a method in which a weighted sum of a difference level between picture signals and a bit amount of a motion vector is used as a measure of a correlation when a frame having a high correlation is determined for each block.

It is to be noted that because the same reference frame list should be set in the decoding end, when a reference frame list is set in accordance with a condition unavailable in the decoding end, it is necessary to encode information necessary to identify the set reference frame list and transmit it to the decoding apparatus.

When the setting of the reference frame list is completed, the conversion table generating unit 107 generates a conversion rule for converting a reference frame index for the texture reference frame list into a reference frame index for the set reference frame list (step S104). Although any method may be used as a method for representing the conversion rule, the present embodiment describes an example in which the conversion rule is represented as a lookup table. First, a lookup table LUT having the same number of entries as the texture reference frame list is prepared. It is assumed that an entry of the lookup table is referred to by supplying a number enclosed in [ ] to LUT. Here, it is assumed that the reference frame index is an integer greater than or equal to 0.

Next, an entry number on the reference frame list of a frame having the same property as a frame for an i^{th} entry of the texture reference frame list is allocated to LUT[i]. Here, the same property means agreement in terms of, for example, a time, camera ID, and/or a method for acquiring a frame (a decoded frame, a synthesized frame, an estimated frame, or the like). Specifically, in H.264, the type of frame is represented by a picture order count (POC) representing the decoding order or by view_id representing a view, and it is determined that frames have the same property if the types of frame agree with each other. It is to be noted that when there is no corresponding frame on the reference frame list, it is assumed that the absence of correspondence is represented by allocating “−1” to LUT[k] for a reference frame index k of the texture reference frame list.

Although frames having the same property are identified here, a correspondence relationship may be generated by finding a frame having the same relative property. That is, the correspondence relationship may be generated by identifying frames in which the POC differences agree with each other rather than frames in which POCs agree with each other.

When the generation of conversion rule is completed, the encoding target depth map is divided into regions each having a predetermined size and a moving picture signal of the encoding target depth map is encoded for every division region (steps S105 to S113). That is, when an encoding target region index is denoted as blk and the total number of encoding target regions of one frame is denoted as numBlks, blk is initialized to 0 (step S105), and then the following process (steps S106 to S111) is iterated until blk reaches numBlks (step S113) while blk is incremented by 1 (step S112). In general coding, the encoding target depth map is divided into processing unit blocks of 16 pixels×16 pixels, each of which is called a macroblock, but the encoding target depth map may be divided into blocks each having another size as long as the size is the same as that on the decoding end.

In the process to be iterated for every encoding target region, first, the motion information converting unit 108 checks whether motion information is shareable (step S106). Specifically, the conversion rule is referred to and it is checked whether there is a reference frame index of the encoding target depth map which corresponds to a reference frame index texRefId[blk] of texture motion information for the encoding target region blk. That is, it is checked whether LUT[texRefId[blk]] is a value other than −1.

If LUT[texRefId[blk]] is a value other than −1, it is determined that the motion information is shareable and the motion information converting unit 108 performs conversion on the texture motion information and sets the converted texture motion information as motion information for the encoding target region blk (step S107). The conversion is performed by changing the texture reference frame index in accordance with LUT and maintaining the vector information representing a correspondence region. That is, a reference frame index RefId[blk] of the motion information for the encoding target region blk is set as LUT[texRefId[blk]], and vector information Vec[blk] is set as texture vector information texVec[blk] corresponding to the encoding target region blk included in the texture motion information.

If LUT[texRefId[blk]] is −1, it is determined that the motion information is not shareable and the motion information setting unit 109 sets the motion information (RefId[blk] and Vec[blk]) for the encoding target region blk (step S108). Although any process may be used for the process to be performed here, the process is generally performed by identifying a region on a reference frame having a picture signal similar to a picture signal in the encoding target region blk. In addition, a region on the reference frame in which a rate distortion cost represented by a weighted sum of the difference between the picture signals and a generated bit amount becomes minimum may be identified in view of not only comparison of picture signals but also a bit amount necessary for encoding the reference frame index and vector information.

If the motion information is not shareable, the motion information encoding unit 111 encodes the set motion information (step S109). Although any encoding method may be used, predictive encoding is generally used. That is, predictive motion information is generated from motion information used in a temporally or spatially adjacent region and only the difference information therebetween is encoded.

When the conversion or encoding of the motion information is completed, the predicted picture generating unit 112 refers to a frame stored in the reference frame memory 115 in accordance with the motion information (RefId[blk] and Vec[blk]) obtained for the encoding target region blk and generates a predicted picture for the encoding target region blk (step S110). Basically, the predicted picture is generated by copying a picture signal of a region designated by the vector information of the motion information in a frame on the reference frame memory 115 represented by the reference frame index of the motion information. However, at the time of copying, pixel interpolation or linear transformation of a pixel value may be performed.

When the generation of the predicted picture is completed, the picture signal encoding unit 113 encodes the picture signal (depth information) of the encoding target region blk using the generated predicted picture (step S111). As long as correct decoding is possible in the decoding end, any method may be used for encoding. In general coding such as MPEG-2 or H.264/AVC, encoding is performed by sequentially performing frequency conversion such as a discrete cosine transform (DCT), quantization, binarization, and entropy encoding on a difference signal between the picture signal of the block blk and the predicted picture.

At this time, a decoded picture that can be obtained in the decoding end is generated from generated encoded data and the result is stored in the reference frame memory 115. Here, a decoded picture may be obtained by actually performing decoding on the encoded data, or a decoded picture may be obtained by a simplified decoding process using data of a process immediately before a lossless process in encoding and the predicted picture. For example, when the encoded data is generated using general coding such as MPEG-2 or H.264/AVC, a decoded picture may be generated by adding the predicted picture to a two-dimensional signal obtained by sequentially performing inverse quantization and inverse frequency conversion on a value to which a quantization process has been applied and clipping the obtained result in the range of a pixel value.

Finally, the multiplexing unit 114 multiplexes the encoded data of the motion information and the encoded data of the picture signal and outputs resultant data. It is to be noted that if it is determined that the motion information is shareable, the encoded data of the motion information is not present, and thus it is not necessary to perform the multiplexing. It is to be noted that the multiplexing may be performed on a block-by-block basis, or the multiplexing may be performed on a frame-by-frame basis.

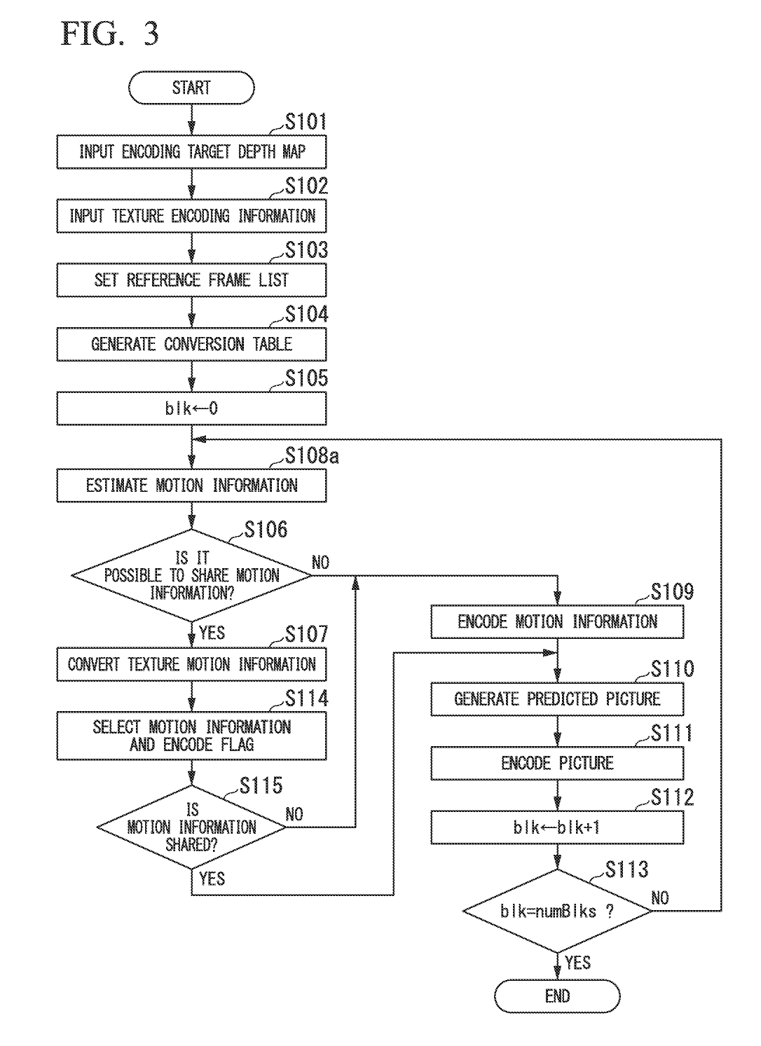

It is to be noted that although the present embodiment assumes that all pieces of shareable motion information are shared, an implementation in which a flag representing whether to share motion information is encoded and only part of the shareable motion information is shared even when the motion information is shareable is also preferable. A processing operation in this case is illustrated in FIG. 3. FIG. 3 is a flowchart illustrating a processing operation when only part of the shareable motion information is shared. In FIG. 3, the same operations as those illustrated in FIG. 2 are assigned the same reference signs and a description thereof is omitted. A first difference between the processing operation illustrated in FIG. 3 and the processing operation illustrated in FIG. 2 is that a process (step S108a) of estimating motion information is executed for all encoding target regions blk. The processing operation differs from that illustrated in FIG. 2 in that the motion information set here is a candidate for motion information for the encoding target region blk and is not necessarily used for the encoding target region blk.

A second difference is that, if the motion information is shareable, after conversion is performed on the texture motion information, a process (step S114) of selecting which one of the motion information obtained by the conversion in step S107 and the motion information set in step S108a is to be used and encoding a flag representing a selection result is executed and the selection (step S115) of whether to encode the motion information is performed in accordance with the selection.

Even when whether to perform sharing for each region is determined in this manner, the present processing operation makes it possible to reduce a generated bit amount and realize efficient coding because it is not necessary to encode flags for all encoding target regions blk and it is necessary to encode flags only for regions in which the motion information is shareable.

In addition, the present embodiment assumes that there is only one type of shareable motion information for each encoding target region. However, it is also conceivable that one piece of motion information is selected from a plurality of types of motion information and it is shared so as to, for example, make it possible to realize sharing with motion information used in an already encoded region spatially or temporally adjacent to the encoding target region. In this case, a list of motion information serving as candidates to be shared is generated and an index on the list is encoded. When the list is created, it is determined whether motion information serving as a candidate to be shared is shareable (corresponding to step S106), the motion information serving as the candidate to be shared is added to the candidate list only if the motion information is shareable, and the motion information serving as the candidate to be shared is excluded from the candidate list if it is not shareable. Thereby, it is possible to reduce the size of the candidate list and reduce a bit amount required for encoding an index on the list.

Here, because a conversion rule is determined in accordance with a reference frame list for motion information before conversion and a reference frame list used by the encoding target region, it is necessary to generate a conversion rule for each piece of motion information corresponding to a different reference frame list. In addition, when the configurations of the two reference frame lists are the same, the conversion rule is unnecessary and it is not necessary to perform the conversion process and the determination process whether to perform sharing. Thus, conversion is unnecessary in many coding schemes because the same reference frame list is used in spatially adjacent regions, and all pieces of motion information are added to the candidate list as candidates to be shared.

In addition, in the present embodiment, the texture reference frame list and the reference frame list having completely different structures can be set, but there is a case in which the same structure is basically used and the size of only the reference frame list is set to be small. In this case, it is not necessary to generate the conversion rule and it may be determined that motion information is not shareable if the reference frame index of the texture motion information is greater than the set size of the reference frame list, otherwise, it may be determined that the motion information is shareable. At this time, because it is not necessary to perform conversion on the motion information, the texture motion information itself is used in generating the predicted picture if the motion information is shareable.

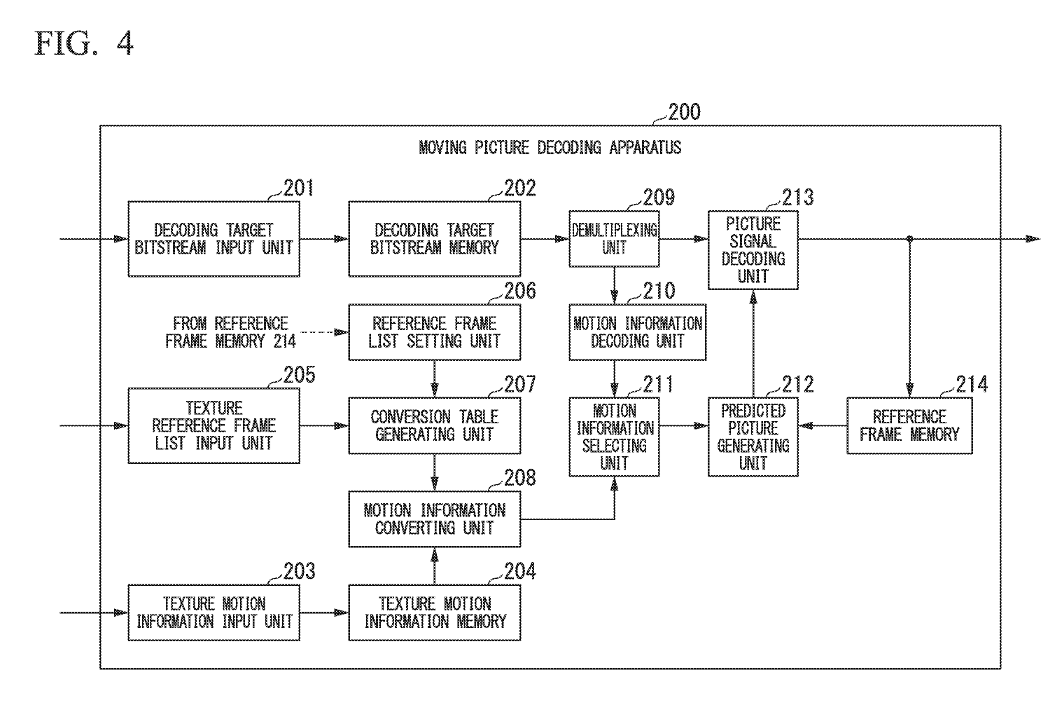

Next, a moving picture decoding apparatus will be described. FIG. 4 is a block diagram illustrating a configuration of the moving picture decoding apparatus in accordance with an embodiment of the present invention. As illustrated in FIG. 4, the moving picture decoding apparatus 200 includes a decoding target bitstream input unit 201, a decoding target bitstream memory 202, a texture motion information input unit 203, a texture motion information memory 204, a texture reference frame list input unit 205, a reference frame list setting unit 206, a conversion table generating unit 207, a motion information converting unit 208, a demultiplexing unit 209, a motion information decoding unit 210, a motion information selecting unit 211, a predicted picture generating unit 212, a picture signal decoding unit 213, and a reference frame memory 214.

The decoding target bitstream input unit 201 inputs a bitstream of a depth map moving picture serving as a decoding target. In the following description, the depth map moving picture to be decoded is referred to as a decoding target depth map moving picture, and a frame to be decoded by the process is particularly referred to as a decoding target depth map. The decoding target bitstream memory 202 stores the input decoding target bitstream. The texture motion information input unit 203 inputs motion information in a frame of a moving picture corresponding to the decoding target depth map. Here, the moving picture corresponding to the decoding target depth map moving picture is referred to as a texture moving picture, and one frame of the moving picture corresponding to the decoding target depth map is referred to as a texture frame. In addition, the motion information is information used when decoding on a bitstream obtained by encoding the texture moving picture is performed and it is represented using a set of a reference frame index and a motion vector for each pixel or block. The texture motion information memory 204 stores the input texture motion information. The texture reference frame list input unit 205 inputs a reference frame list used when the texture frame is decoded.

The reference frame list setting unit 206 sets a reference frame list to be used in decoding of the decoding target depth map. The conversion table generating unit 207 generates a lookup table which converts a reference frame index for the texture reference frame list into a reference frame index for the reference frame list. The motion information converting unit 208 performs conversion on the reference frame index in the texture motion information in accordance with the generated lookup table.

The demultiplexing unit 209 demultiplexes encoded data of motion information and encoded data of a picture signal multiplexed in the input bitstream. The motion information decoding unit 210 decodes part of motion information for the decoding target depth map from the encoded data of the motion information. The motion information selecting unit 211 selects either one of motion information obtained by converting the texture motion information and the motion information decoded by the motion information decoding unit 210.

The predicted picture generating unit 212 generates a predicted picture for the decoding target depth map in accordance with the selected motion information. The picture signal decoding unit 213 generates a decoded depth map by performing decoding on the encoded data of the picture signal using the generated predicted picture. The reference frame memory 214 stores an already decoded depth map to be used to generate the predicted picture.

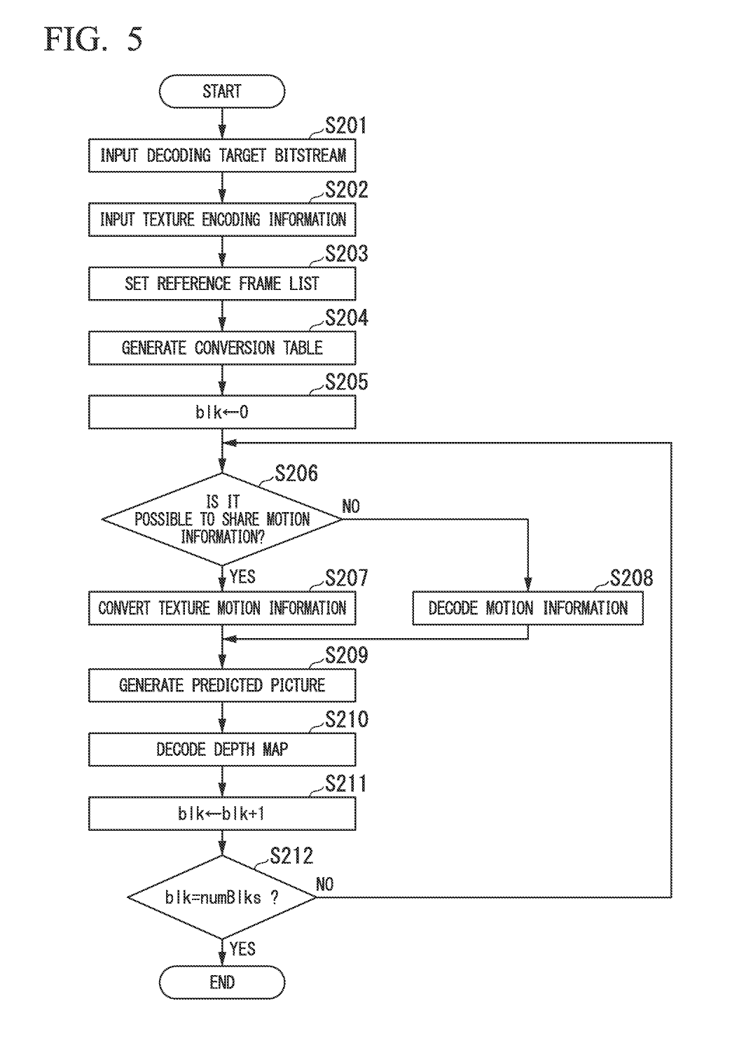

Next, an operation of the moving picture decoding apparatus 200 illustrated in FIG. 4 will be described with reference to FIG. 5. FIG. 5 is a flowchart illustrating the operation of the moving picture decoding apparatus 200 illustrated in FIG. 4. Here, a process of decoding one certain frame in a decoding target depth map moving picture will be described. It is possible to realize decoding of the depth map moving picture by iterating the process to be described for every block.

First, the decoding target bitstream input unit 201 inputs encoded data of a decoding target depth map moving picture and stores it in the decoding target bitstream memory 202 (step S201). Next, the texture motion information input unit 203 inputs motion information used when a texture frame is decoded and stores it in the texture motion information memory 204. In parallel therewith, the texture reference frame list input unit 205 inputs a texture reference frame list which is a reference frame list used when the texture frame is decoded (step S202).

It is to be noted that it is assumed that some frames of the decoding target depth map moving picture are already decoded and their decoded frames are stored in the reference frame memory 214. Moreover, in addition to the decoded frames, any frame available in the encoding end may be included in the reference frame memory 214. However, the same frame as that of the encoding end has to be stored. For example, when a multiview depth map moving picture is decoded, an implementation in which a frame obtained by decoding a depth map moving picture for another view and/or a frame obtained by synthesizing a depth map of a view for the decoding target depth map moving picture using the frame obtained by decoding the depth map moving picture for the other view are included in the reference frame memory 214 is preferable. Furthermore, an implementation in which a depth map estimated by stereo matching using a multiview moving picture obtained by decoding a corresponding multiview moving picture is included in the reference frame memory 214 is also preferable.

In addition, here, it is assumed that decoding target depth maps are sequentially decoded from the input bitstream and are output, the input order does not necessarily agree with the output order. If the input order is different from the output order, a decoded frame is stored in the reference frame memory 214 until the next frame to be output is decoded. Then, a frame stored in the reference frame memory 214 is output from the moving picture decoding apparatus 200 in accordance with the separately defined output order. It is to be noted that the timing at which a frame is deleted from the reference frame memory 214 is determined in accordance with a reference structure to be used for prediction, and it is a point in time at which it is determined that the frame is no longer used as a reference frame when subsequent decoding target depth maps are decoded or it is any timing thereafter.

Here, although the decoding target bitstream and the texture motion information are input on a frame-by-frame basis, either one or both thereof may be input on a sequence-by-sequence basis. In this case, in step S202, a texture reference frame list of each frame is input and a memory for storing the input texture reference frame list is necessary. In addition, either one or both of the decoding target bitstream and the texture motion information may be input for each decoding processing unit. In this case, because the input signals are sequentially processed, the decoding target bitstream memory 202 and the texture motion information memory 204 are unnecessary.

When the decoding target bitstream and the texture motion information are stored and the input of the texture reference frame list is completed, the reference frame list setting unit 206 sets a reference frame list to be used when the decoding target depth map is decoded (step S203). Specifically, reference frame indices are allocated to frames stored in the reference frame memory 214 without overlap. It is to be noted that the reference frame indices do not necessarily have to be allocated to all frames stored in the reference frame memory 214. In addition, when a plurality of reference frame lists are created, reference frame indices are allocated for each reference frame list without overlap. The reference frame list to be created here has to be the same as that used at the time of encoding. That is, the reference frame list is created in accordance with the same separately defined rule, or information for identifying a reference frame list used at the time of encoding is separately given and setting is performed in accordance therewith. When the information for identifying the reference frame list used at the time of encoding is included in the bitstream, the information is obtained by performing decoding thereon.

When the setting of the reference frame list is completed, the conversion table generating unit 207 generates a conversion rule for converting a reference frame index for the texture reference frame list into a reference frame index for the set reference frame list (step S204). The process here is the same as the above-described step S104.

When the generation of the conversion rule is completed, the decoding target depth map is divided into regions each having a predetermined size and a moving picture signal of the decoding target depth map is decoded for every divided region (steps S205 to S212). That is, when a decoding target region index is denoted as blk and the total number of decoding target regions of one frame is denoted as numBlks, blk is initialized to 0 (step S205) and then the following process (steps S206 to S210) is iterated until blk reaches numBlks (step S212) while blk is incremented by 1 (step S211). The size of the processing region becomes the same as that used in the encoding end. Although a processing unit block of 16 pixels×16 pixels called a macroblock is used in general coding, the process is performed for each block having another size as long as the size is the same as that on the encoding end.

In the process to be iterated for every decoding target region, first, the motion information converting unit 208 checks whether motion information is shareable (step S206). The process here is the same as the above-described step S106. If the motion information is shareable, the motion information converting unit 208 performs conversion on texture motion information and sets the result as motion information for a decoding target region blk (step S207). The process here is the same as the above-described step S107.

If the motion information is not shareable, the demultiplexing unit 209 demultiplexes encoded data of motion information for the decoding target region blk from the decoding target bitstream and the motion information decoding unit 210 performs decoding on the encoded data to obtain motion information for the decoding target region blk (step S208). It is to be noted that a method for decoding the motion information from the demultiplexed encoded data is determined depending on an encoding method. In general, because the motion information is subjected to predictive encoding, predictive motion information is generated from motion information used in a temporally or spatially adjacent region and the motion information is decoded by adding difference motion information obtained by performing decoding on the encoded data to the predictive motion information. In addition, as long as it is possible to decode the motion information for the decoding target region blk from the decoding target bitstream, the encoded data of the motion information for the decoding target region blk does not necessarily have to be demultiplexed from the decoding target bitstream.

When the conversion or decoding of the motion information is completed, the predicted picture generating unit 212 refers to a frame stored in the reference frame memory 214 in accordance with the motion information obtained for the decoding target region blk and generates a predicted picture for the decoding target region blk (step S209). The process here is the same as the above-described step S110.

When the generation of the predicted picture is completed, the demultiplexing unit 209 demultiplexes encoded data of a picture signal (depth information) for the decoding target region blk from the decoding target bitstream and the picture signal decoding unit 213 decodes the picture signal (depth information) for the decoding target region blk from the encoded data using the generated predicted picture (step S210). The decoding result serves as an output of the moving picture decoding apparatus 200 and is stored in the reference frame memory 214. The decoding process uses a technique corresponding to a technique used at the time of encoding. For example, when general coding such as MPEG-2 or H.264/AVC is used, the picture signal is decoded by sequentially performing entropy decoding, inverse binarization, inverse quantization, and inverse frequency conversion such as an inverse discrete cosine transform (IDCT), adding the predicted picture to an obtained two-dimensional signal, and finally clipping the obtained result in the range of a pixel value.

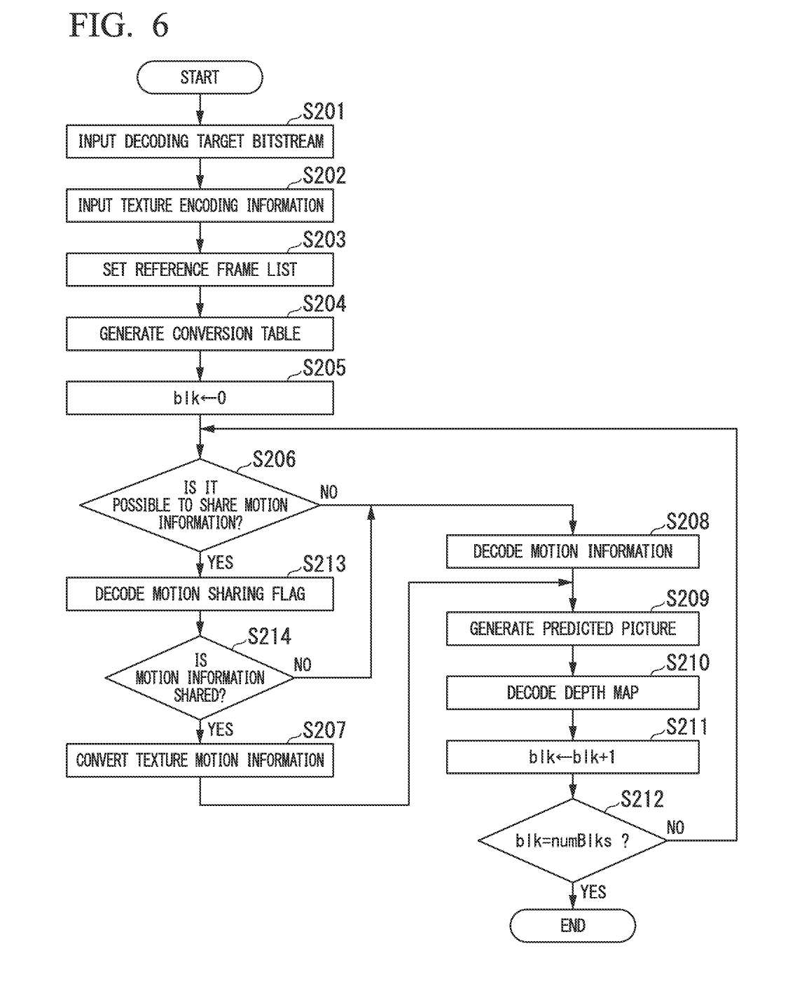

It is to be noted that although the above description assumes that all shareable motion information is shared, an implementation in which a flag representing whether to perform sharing is encoded and only part of the sharable motion information is shared in accordance with the flag even when the motion information is sharable is also preferable. A processing operation of this case is illustrated in FIG. 6. FIG. 6 is a flowchart illustrating the processing operation when only part of the shareable motion information is shared. The same operations as those illustrated in FIG. 5 are assigned the same reference signs in FIG. 6 and a description thereof is omitted. The differences between the processing operation illustrated in FIG. 6 and the processing operation illustrated in FIG. 5 are as follows. If the motion information is shareable (YES in step S206), a flag representing whether to share the motion information is first decoded (step S213) and it is checked whether the flag represents that the motion information is shared (step S214). Then, if the flag represents that the motion information is shared, the motion information converting unit 208 performs conversion on texture motion information and sets the result as motion information for the decoding target region blk (step S207). Otherwise, the motion information decoding unit 210 performs decoding on the encoded data to obtain the motion information for the decoding target region blk (step S208).

Even when whether to share the motion information for each region is determined in this manner, it is possible to reduce a bit amount for flags and realize efficient coding because it is sufficient to perform decoding based on the fact that flags are not encoded for all encoding target regions blk but flags are encoded only for regions in which motion information is shareable.

In addition, here, it is assumed that there is only one type of shareable motion information for each decoding target region. However, it is conceivable that one piece of motion information is selected from a plurality of types of motion information and it is shared so as to, for example, make it possible to realize sharing with motion information used in an already decoded region spatially or temporally adjacent to the decoding target region. In this case, a list of motion information serving as candidates to be shared is generated and an index on the list is decoded from the bitstream. When the list is created, it is determined whether motion information serving as a candidate to be shared is shareable (corresponding to step S206), the motion information serving as the candidate to be shared is added to a candidate list only if the motion information is shareable, and the motion information serving as the candidate to be shared is excluded from the candidate list if it is not shareable. Thereby, it is possible to reduce the size of the candidate list and designate an index on the list using a small bit amount.

Here, because a conversion rule is designated in accordance with a reference frame list for motion information before conversion and a reference frame list used by the decoding target region, it is necessary to generate a conversion rule for each piece of motion information corresponding to a different reference frame list. In addition, when the configurations of the two reference frame lists are the same, the conversion rule is unnecessary and it is not necessary to perform the conversion process and the determination process whether to perform sharing. Thus, in many coding schemes, conversion is unnecessary because the same reference frame list is used in spatially adjacent regions, and all pieces of motion information are added to the candidate list as candidates to be shared.

In addition, the texture reference frame list and the reference frame list having completely different structures can be set, but there is a case in which the same structure is basically used and the size of only the reference frame list is set to be small. In this case, it is not necessary to generate the conversion rule and it may be determined that the motion information is not shareable if the reference frame index of the texture motion information is greater than the set size of the reference frame list, otherwise, it may be determined that the motion information is shareable. At this time, because it is not necessary to perform conversion on the motion information, the texture motion information itself is used in generating the predicted picture if the motion information is shareable.

As described above, if motion information at the time of encoding a moving picture for an encoding target depth map is also obtained by the decoding end, it is determined whether to reuse the motion information in accordance with the presence/absence of a reference frame represented by the motion information, and a predicted picture is generated using motion information converted in consideration of a reference structure if the motion information is diverted. Thereby, when the depth map is encoded, it is possible to perform coding using a reference structure which is different from that at the time of coding the moving picture, and thus it is possible to realize efficient coding using a temporal correlation of the depth map having a different property from the moving picture. In addition, by determining whether to reuse the motion information in accordance with the presence/absence of the reference frame, it is possible to reduce a bit amount for representing its information.

Although the above description describes a process of encoding/decoding a moving picture for one view, the embodiment of the present invention is also applicable to a process of encoding/decoding a multiview picture or a multiview moving picture captured by a plurality of cameras. In addition, although the above description describes a process of encoding/decoding the entire frame, the process of the embodiment of the present invention can also be applied to only part of a frame. In this case, whether to apply the process may be determined and a flag representing the result may be encoded/decoded, or the result may be designated by some other means.

It is to be noted that the moving picture encoding process and the moving picture decoding process may be performed by recording a program for realizing functions of the moving picture encoding apparatus 100 illustrated in FIG. 1 and the moving picture decoding apparatus 200 illustrated in FIG. 4 on a computer-readable recording medium and causing a computer system to read and execute the program recorded on the recording medium. It is to be noted that the “computer system” used here may include an operating system (OS) and hardware such as peripheral devices. In addition, the “computer system” may include a World Wide Web (WWW) system having a homepage providing environment (or displaying environment). In addition, the “computer-readable recording medium” refers to a portable medium such as a flexible disk, a magneto-optical disc, a read only memory (ROM), or a compact disc (CD)-ROM, and a storage apparatus such as a hard disk embedded in the computer system. Furthermore, the “computer-readable recording medium” may include a medium that holds a program for a constant period of time, such as a volatile memory (random access memory (RAM)) inside a computer system serving as a server or a client when the program is transmitted via a network such as the Internet or a communication circuit such as a telephone circuit.

In addition, the above program may be transmitted from a computer system storing the program in a storage apparatus or the like via a transmission medium or transmission waves in the transmission medium to another computer system. Here, the “transmission medium” for transmitting the program refers to a medium having a function of transmitting information, such as a network (communication network) like the Internet or a communication circuit (communication line) like a telephone circuit. In addition, the above program may be a program for realizing part of the above-described functions. Furthermore, the above program may be a program, i.e., a so-called differential file (differential program), capable of realizing the above-described functions in combination with a program already recorded on the computer system.

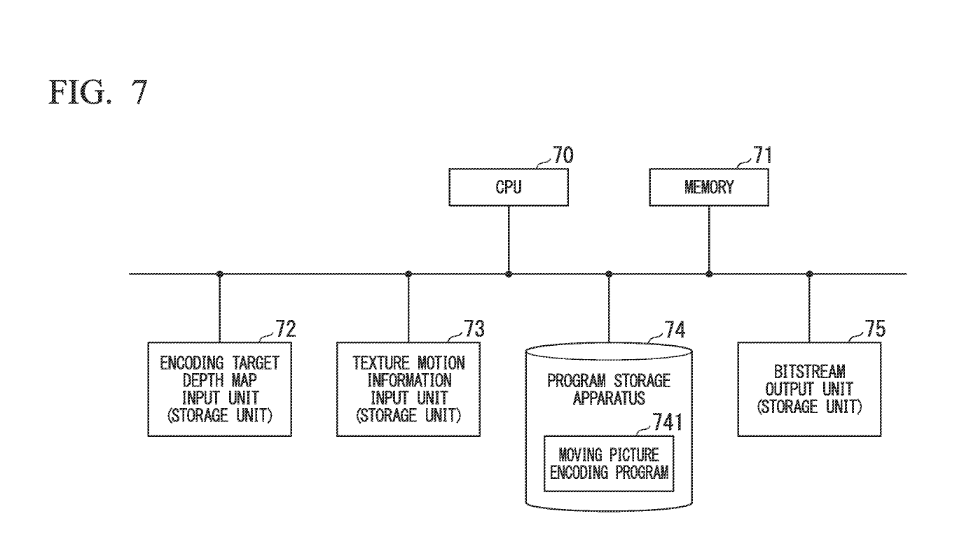

FIG. 7 illustrates an example of a configuration of hardware when the moving picture encoding apparatus is configured by a computer and a software program. The present system is configured so that a central processing unit (CPU) 70 which executes the program, a memory 71 such as a random access memory (RAM) which stores the program and data to be accessed by the CPU 70, an encoding target depth map input unit 72 (which may be a storage unit which stores a moving picture signal of a depth map by a disk apparatus or the like) which inputs a signal of a depth map serving as an encoding target from a camera or the like, a texture motion information input unit 73 (which may be a storage unit which stores motion information by the disk apparatus or the like) which inputs motion information of a moving picture for the encoding target depth map, for example, via a network, a program storage apparatus 74 which stores a moving picture encoding program 741 which is a software program for causing the CPU 70 to execute the process illustrated in FIG. 2 or 3, and a bitstream output unit 75 (which may be a storage unit which store a bitstream by the disk apparatus or the like) which outputs a bitstream generated by executing the moving picture encoding program 741 loaded by the CPU 70 to the memory 71, for example, via the network, are connected by a bus. Although not illustrated, other hardware such as a reference frame list input unit and a reference frame storage unit is provided and used in implementing the present technique. In addition, a moving picture signal encoded data storage unit, a motion information encoded data storage unit, and the like may be used.

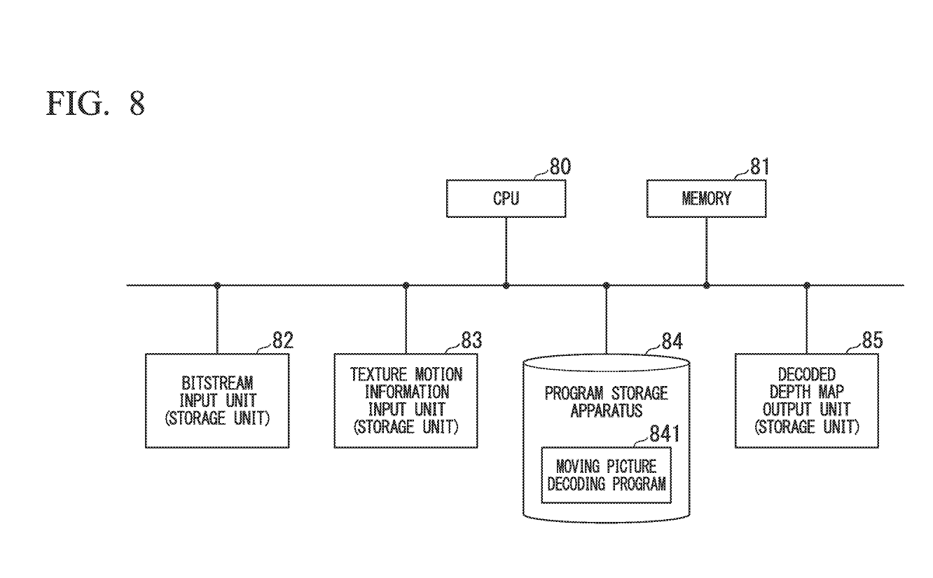

FIG. 8 illustrates an example of a configuration of hardware when the moving picture decoding apparatus is configured by a computer and a software program. The present system is configured so that a CPU 80 which executes the program, a memory 81 such as a RAM which stores the program and data to be accessed by the CPU 80, a bitstream input unit 82 (which may be a storage unit which stores a bitstream by a disk apparatus or the like) which inputs a bitstream encoded by the moving picture encoding apparatus in accordance with the present technique, a texture motion information input unit 83 (which may be a storage unit which stores motion information by the disk apparatus or the like) which inputs motion information of a moving picture for a decoding target depth map, for example, via a network, a program storage apparatus 84 which stores a moving picture decoding program 841 which is a software program for causing the CPU 80 to execute the process illustrated in FIG. 5 or 6, and a decoded depth map output unit 85 which outputs a decoded depth map obtained by performing decoding on the bitstream to a reproduction apparatus or the like by executing the moving picture decoding program 841 loaded by the CPU 80 to the memory 81 are connected by a bus. Although not illustrated, other hardware such as a reference frame list input unit and a reference frame storage unit is provided and used in implementing the present technique. In addition, a moving picture signal encoded data storage unit, a motion information encoded data storage unit, and the like may be used.

As described above, it is possible to increase coding efficiency by sharing motion information to be used when predictive coding is performed on a moving picture and a depth map moving picture and generating a predicted picture adaptively using the motion information.

While the embodiments of the present invention have been described above with reference to the drawings, it is apparent that the above embodiments are exemplary of the present invention and the present invention is not limited to the above embodiments. Accordingly, additions, omissions, substitutions, and other modifications of constituent elements may be made without departing from the technical idea and scope of the present invention.

### INDUSTRIAL APPLICABILITY

The present invention is applicable for essential use in realizing efficient moving picture coding in coding a free viewpoint moving picture having a moving picture and a depth map moving picture as constituent elements.

### DESCRIPTION OF REFERENCE SIGNS

101 Encoding target depth map input unit
102 Encoding target depth map memory
103 Texture motion information input unit
104 Texture motion information memory
105 Texture reference frame list input unit
106 Reference frame list setting unit
107 Conversion table generating unit
108 Motion information converting unit
109 Motion information setting unit
110 Motion information selecting unit
111 Motion information encoding unit
112 Predicted picture generating unit
113 Picture signal encoding unit
114 Multiplexing unit
115 Reference frame memory
201 Decoding target bitstream input unit
202 Decoding target bitstream memory
203 Texture motion information input unit
204 Texture motion information memory
205 Texture reference frame list input unit
206 Reference frame list setting unit
207 Conversion table generating unit
208 Motion information converting unit
209 Demultiplexing unit
210 Motion information decoding unit
211 Motion information selecting unit
212 Predicted picture generating unit
213 Picture signal decoding unit
214 Reference frame memory

1. A moving picture encoding method for dividing each frame constituting a depth map moving picture into processing regions each having a predetermined size and performing predictive encoding for each of the processing regions while using motion information when a texture moving picture corresponding to the depth map moving picture is encoded, the method comprising:
a depth map reference frame list generating step of generating a depth map reference frame list which is a list of reference frames to be referred to when a predicted picture is generated;
a texture motion information setting step of setting motion information used when the texture moving picture corresponding to a processing region is encoded as texture motion information;
a depth map motion information setting step of setting depth map motion information representing a region on a reference frame corresponding to the processing region, the depth map motion information setting step setting the texture motion information as the depth map motion information if an index value which is included in the texture motion information and which designates a reference frame on a texture reference frame list which is a list of reference frames used when the texture moving picture is encoded is less than the size of the depth map reference frame list; and
a predicted picture generating step of generating the predicted picture for the processing region in accordance with the set depth map motion information.

2. A moving picture encoding method for dividing each frame constituting a depth map moving picture into processing regions each having a predetermined size and performing predictive encoding for each of the processing regions while using motion information when a texture moving picture corresponding to the depth map moving picture is encoded, the method comprising:
a depth map reference frame list generating step of generating a reference frame list which is a list of reference frames to be referred to when a predicted picture is generated;
a texture motion information setting step of setting motion information used when the texture moving picture corresponding to a processing region is encoded as texture motion information;
a depth map motion information setting step of setting depth map motion information representing a region on a reference frame corresponding to the processing region, the depth map motion information setting step setting, if a frame having the same property as a frame represented by the texture motion information is included in the reference frame list, motion information in which a reference frame index of the texture motion information is changed to an index representing the frame having the same property, as the depth map motion information; and
a predicted picture generating step of generating the predicted picture for the processing region in accordance with the set depth map motion information.

3. The moving picture encoding method according to claim 2, further comprising:
a texture reference frame list setting step of setting a reference frame list used when the texture moving picture is encoded as a texture reference frame list;
a conversion table generating step of generating a conversion table which converts a reference frame index for the texture reference frame list into a reference frame index for the reference frame list, the conversion table generating step setting the conversion table so that a property of a frame within the texture reference frame list represented by the reference frame index before conversion is equal to a property of a frame within the reference frame list represented by the reference frame index after the conversion; and
a motion information converting step of generating converted motion information by performing conversion on an index value designating a reference frame included in the texture motion information in accordance with the conversion table,
wherein the depth map motion information setting step sets the converted motion information as the depth map motion information if the frame having the same property as the frame represented by the texture motion information is included in the reference frame list.

4. A moving picture encoding method for dividing each frame constituting a depth map moving picture into processing regions each having a predetermined size and performing predictive encoding for each of the processing regions while using motion information when a texture moving picture corresponding to the depth map moving picture is encoded, the method comprising:
a depth map reference frame list generating step of generating a reference frame list which is a list of reference frames to be referred to when a predicted picture is generated;
a texture motion information setting step of setting motion information used when the texture moving picture corresponding to a processing region is encoded as texture motion information;
a shared motion information list generating step of generating a shared motion information list generated by listing motion information used when a region temporally or spatially adjacent to the processing region is encoded, the shared motion information list generating step generating the shared motion information list including the texture motion information if an index value designating a reference frame included in the texture motion information is less than the size of the reference frame list;
a depth map motion information setting step of selecting one piece of motion information from the motion information included in the shared motion information list and setting the selected motion information as motion information for the processing region; and
a predicted picture generating step of generating the predicted picture for the processing region in accordance with the set depth map motion information.

5. A moving picture encoding method for dividing each frame constituting a depth map moving picture into processing regions each having a predetermined size and performing predictive encoding for each of the processing regions while using motion information when a texture moving picture corresponding to the depth map moving picture is encoded, the method comprising:
a depth map reference frame list generating step of generating a reference frame list which is a list of reference frames to be referred to when a predicted picture is generated;
a texture motion information setting step of setting motion information used when the texture moving picture corresponding to a processing region is encoded as texture motion information;
a shared motion information list generating step of generating a shared motion information list generated by listing motion information used when a region temporally or spatially adjacent to the processing region is encoded, the shared motion information list generating step generating, if a frame having the same property as a frame represented by the texture motion information is included in the reference frame list, the shared motion information list including motion information in which a reference frame index of the texture motion information is changed to an index representing the frame having the same property;
a depth map motion information setting step of selecting one piece of motion information from the motion information included in the shared motion information list and setting the selected motion information as motion information for the processing region; and
a predicted picture generating step of generating the predicted picture for the processing region in accordance with the set depth map motion information.

6. The moving picture encoding method according to claim 5, further comprising:
a texture reference frame list setting step of setting a reference frame list used when the texture moving picture is encoded as a texture reference frame list;
a conversion table generating step of generating a conversion table which converts a reference frame index for the texture reference frame list into a reference frame index for the reference frame list, the conversion table generating step setting the conversion table so that a property of a frame within the texture reference frame list represented by the reference frame index before conversion is equal to a property of a frame within the reference frame list represented by the reference frame index after the conversion; and
a motion information converting step of generating converted motion information by performing conversion on an index value designating a reference frame included in the texture motion information in accordance with the conversion table,
wherein the shared motion information list generating step generates the shared motion information list including the converted motion information if the frame having the same property as the frame represented by the texture motion information is included in the reference frame list.

7. A moving picture decoding method for, when decoding is performed on encoded data of a depth map moving picture, dividing each frame constituting the depth map moving picture into processing regions each having a predetermined size and performing decoding while predicting a depth map for each of the processing regions using motion information used when a texture moving picture corresponding to the depth map moving picture is decoded, the method comprising:
a depth map reference frame list setting step of setting a depth map reference frame list which is a list of reference frames to be referred to when a predicted picture is generated;
a texture motion information setting step of setting motion information used when the texture moving picture corresponding to a processing region is decoded as texture motion information;
a depth map motion information setting step of setting depth map motion information representing a region on a reference frame corresponding to the processing region, the depth map motion information setting step setting the texture motion information as the depth map motion information if an index value which is included in the texture motion information and which designates a reference frame on a texture reference frame list which is a list of reference frames used when the texture moving picture is decoded is less than the size of the depth map reference frame list; and
a predicted picture generating step of generating the predicted picture for the processing region in accordance with the set depth map motion information.

8. A moving picture decoding method for, when decoding is performed on encoded data of a depth map moving picture, dividing each frame constituting the depth map moving picture into processing regions each having a predetermined size and performing decoding while predicting a depth map for each of the processing regions using motion information used when a texture moving picture corresponding to the depth map moving picture is decoded, the method comprising:
a depth map reference frame list setting step of setting a reference frame list which is a list of reference frames to be referred to when a predicted picture is generated;
a texture motion information setting step of setting motion information used when the texture moving picture corresponding to a processing region is decoded as texture motion information;
a depth map motion information setting step of setting depth map motion information representing a region on a reference frame corresponding to the processing region, the depth map motion information setting step setting, if a frame having the same property as a frame represented by the texture motion information is included in the reference frame list, motion information in which a reference frame index of the texture motion information is changed to an index representing the frame having the same property, as the depth map motion information; and
a predicted picture generating step of generating the predicted picture for the processing region in accordance with the set depth map motion information.

9. The moving picture decoding method according to claim 8, further comprising:
a texture reference frame list setting step of setting a reference frame list used when the texture moving picture is decoded as a texture reference frame list;
a conversion table generating step of generating a conversion table which converts a reference frame index for the texture reference frame list into a reference frame index for the reference frame list, the conversion table generating step setting the conversion table so that a property of a frame within the texture reference frame list represented by the reference frame index before conversion is equal to a property of a frame within the reference frame list represented by the reference frame index after the conversion; and
a motion information converting step of generating converted motion information by performing conversion on an index value designating a reference frame included in the texture motion information in accordance with the conversion table,
wherein the depth map motion information setting step sets the converted motion information as the depth map motion information if the frame having the same property as the frame represented by the texture motion information is included in the reference frame list.

10. A moving picture decoding method for, when decoding is performed on encoded data of a depth map moving picture, dividing each frame constituting the depth map moving picture into processing regions each having a predetermined size and performing decoding while predicting a signal of a depth map for each of the processing regions using motion information used when a texture moving picture corresponding to the depth map moving picture is decoded, the method comprising:
a depth map reference frame list setting step of setting a reference frame list which is a list of reference frames to be referred to when a predicted picture is generated;
a texture motion information setting step of setting motion information used when the texture moving picture corresponding to a processing region is decoded as texture motion information;
a shared motion information list generating step of generating a shared motion information list generated by listing motion information used when a region temporally or spatially adjacent to the processing region is decoded, the shared motion information list generating step generating the shared motion information list including the texture motion information if an index value designating a reference frame included in the texture motion information is less than the size of the reference frame list;
a depth map motion information setting step of selecting one piece of motion information from the motion information included in the shared motion information list and setting the selected motion information as motion information for the processing region; and
a predicted picture generating step of generating the predicted picture for the processing region in accordance with the set depth map motion information.

11. A moving picture decoding method for, when decoding is performed on encoded data of a depth map moving picture, dividing each frame constituting the depth map moving picture into processing regions each having a predetermined size and performing decoding while predicting a signal of a depth map for each of the processing regions using motion information used when a texture moving picture corresponding to the depth map moving picture is decoded, the method comprising:
a depth map reference frame list setting step of setting a reference frame list which is a list of reference frames to be referred to when a predicted picture is generated;
a texture motion information setting step of setting motion information used when the texture moving picture corresponding to a processing region is decoded as texture motion information;
a shared motion information list generating step of generating a shared motion information list generated by listing motion information used when a region temporally or spatially adjacent to the processing region is decoded, the shared motion information list generating step generating, if a frame having the same property as a frame represented by the texture motion information is included in the reference frame list, the shared motion information list including motion information in which a reference frame index of the texture motion information is changed to an index representing the frame having the same property;
a depth map motion information setting step of selecting one piece of motion information from the motion information included in the shared motion information list and setting the selected motion information as motion information for the processing region; and
a predicted picture generating step of generating the predicted picture for the processing region in accordance with the set depth map motion information.

12. The moving picture decoding method according to claim 11, further comprising:
a texture reference frame list setting step of setting a reference frame list used when the texture moving picture is decoded as a texture reference frame list;
a conversion table generating step of generating a conversion table which converts a reference frame index for the texture reference frame list into a reference frame index for the reference frame list, the conversion table generating step setting the conversion table so that a property of a frame within the texture reference frame list represented by the reference frame index before conversion is equal to a property of a frame within the reference frame list represented by the reference frame index after the conversion; and
a motion information converting step of generating converted motion information by performing conversion on an index value designating a reference frame included in the texture motion information in accordance with the conversion table,
wherein the shared motion information list generating step generates the shared motion information list including the converted motion information if the frame having the same property as the frame represented by the texture motion information is included in the reference frame list.

13. A moving picture encoding apparatus for dividing each frame constituting a depth map moving picture into processing regions each having a predetermined size and performing predictive encoding for each of the processing regions while using motion information when a texture moving picture corresponding to the depth map moving picture is encoded, the apparatus comprising:
a depth map reference frame list generating unit which generates a depth map reference frame list which is a list of reference frames to be referred to when a predicted picture is generated;
a texture motion information setting unit which sets motion information used when the texture moving picture corresponding to a processing region is encoded as texture motion information;
a depth map motion information setting unit which sets depth map motion information representing a region on a reference frame corresponding to the processing region, the depth map motion information setting unit setting the texture motion information as the depth map motion information if an index value which is included in the texture motion information and which designates a reference frame on a texture reference frame list which is a list of reference frames used when the texture moving picture is encoded is less than the size of the depth map reference frame list; and
a predicted picture generating unit which generates the predicted picture for the processing region in accordance with the set depth map motion information.

14. A moving picture encoding apparatus for dividing each frame constituting a depth map moving picture into processing regions each having a predetermined size and performing predictive encoding for each of the processing regions while using motion information when a texture moving picture corresponding to the depth map moving picture is encoded, the apparatus comprising:
a depth map reference frame list generating unit which generates a reference frame list which is a list of reference frames to be referred to when a predicted picture is generated;
a texture motion information setting unit which sets motion information used when the texture moving picture corresponding to a processing region is encoded as texture motion information;
a shared motion information list generating unit which generates a shared motion information list generated by listing motion information used when a region temporally or spatially adjacent to the processing region is encoded, the shared motion information list generating unit generating the shared motion information list including the texture motion information if an index value designating a reference frame included in the texture motion information is less than the size of the reference frame list;
a depth map motion information setting unit which selects one piece of motion information from the motion information included in the shared motion information list and sets the selected motion information as motion information for the processing region; and
a predicted picture generating unit which generates the predicted picture for the processing region in accordance with the set depth map motion information.

15. A moving picture decoding apparatus for, when decoding is performed on encoded data of a depth map moving picture, dividing each frame constituting the depth map moving picture into processing regions each having a predetermined size and performing decoding while predicting a depth map for each of the processing regions using motion information used when a texture moving picture corresponding to the depth map moving picture is decoded, the apparatus comprising:
a depth map reference frame list setting unit which sets a depth map reference frame list which is a list of reference frames to be referred to when a predicted picture is generated;
a texture motion information setting unit which sets motion information used when the texture moving picture corresponding to a processing region is decoded as texture motion information;
a depth map motion information setting unit which sets depth map motion information representing a region on a reference frame corresponding to the processing region, the depth map motion information setting unit setting the texture motion information as the depth map motion information if an index value which is included in the texture motion information and which designates a reference frame on a texture reference frame list which is a list of reference frames used when the texture moving picture is decoded is less than the size of the depth map reference frame list; and
a predicted picture generating unit which generates the predicted picture for the processing region in accordance with the set depth map motion information.

16. A moving picture decoding apparatus for, when decoding is performed on encoded data of a depth map moving picture, dividing each frame constituting the depth map moving picture into processing regions each having a predetermined size and performing decoding while predicting a signal of a depth map for each of the processing regions using motion information used when a texture moving picture corresponding to the depth map moving picture is decoded, the apparatus comprising:
a depth map reference frame list setting unit which sets a reference frame list which is a list of reference frames to be referred to when a predicted picture is generated;
a texture motion information setting unit which sets motion information used when the texture moving picture corresponding to a processing region is decoded as texture motion information;
a shared motion information list generating unit which generates a shared motion information list generated by listing motion information used when a region temporally or spatially adjacent to the processing region is decoded, the shared motion information list generating unit generating the shared motion information list including the texture motion information if an index value designating a reference frame included in the texture motion information is less than the size of the reference frame list;
a depth map motion information setting unit which selects one piece of motion information from the motion information included in the shared motion information list and sets the selected motion information as motion information for the processing region; and
a predicted picture generating unit which generates the predicted picture for the processing region in accordance with the set depth map motion information.

17. A moving picture encoding program for causing a computer to execute the moving picture encoding method according to any one of claims 1 to 6.

18. A moving picture decoding program for causing a computer to execute the moving picture decoding method according to any one of claims 7 to 12.

19. A computer-readable recording medium recording the moving picture encoding program according to claim 17.

20. A computer-readable recording medium recording the moving picture decoding program according to claim 18.
